(19) United States
(12) Patent Application Publication
(10) Pub. No.: US 2010/0253545 A1
(43) Pub. Date: Oct. 7, 2010

(54) SIGNAL LAMP FOR PEDESTRIAN

(76) Inventor: Jong-Hwi HAN, Yeonsu-gu (KR)

Correspondence Address: JORDAN AND HAMBURG LLP, 122 EAST 42ND STREET, SUITE 4000, NEW YORK, NY, 10168, US

(21) Appl. No.: 12/726,852

(22) Filed: Mar. 18, 2010

(30) Foreign Application Priority Data
Mar. 18, 2009 (KR) 20-2009-0003114

(51) Int. Cl. G08G 1/095

(52) U.S. Cl. 340/944

(57) ABSTRACT

A signal lamp for a pedestrian—includes a body that has a first surface, a second surface facing the first surface, and at least three side surfaces formed between the first surface and the second surface; display modules that are formed on at least three surfaces directing to different directions among the first surface, the second surface, and the three side surfaces and visually displays individually designated information; and a control module that is installed at the body and controls information that is individually displayed on the display modules, wherein at least first display module of the display modules that are formed at least three surfaces, respectively, by the control operation of the control module is operated to display the information that instructs the passage or stop of the pedestrian.

### CROSS-REFERENCE TO RELATED APPLICATION

This application claims the benefit under 35 U.S.C. §119(a) of Korean Patent Application No. 10-2009-00XXXXX, filed on Feb. 0, 2009, the disclosure of which is incorporated herein in its entirety by reference.

### BACKGROUND OF THE INVENTION

1. Field of the Invention

The present invention relates to a signal lamp for a pedestrian and more particularly, to a signal lamp for a pedestrian that is installed at an intersection or a crosswalk to display a walking display signal and a stop display signal for a pedestrian as well as to improve visibility by effectively displaying various additional information in several directions.

2. Description of the Related Art

Generally, a signal lamp for a pedestrian is configured to include a walking signal display unit that displays a pedestrian display so that a pedestrian can cross a crosswalk and a stop signal display unit that displays a stop display so that a pedestrian does not cross a crosswalk, such that it provides a simple walking signal system that sequentially turns-on only the walking display lamp and the stop display lamp for a predetermined time.

The signal lamp for a pedestrian configured as described above has a disadvantage in that it bores walking waiters since the walking waiters watch only the walking display and the stop display of the signal lamp for a pedestrian or stare at walking waiters at an opposite side without speaking, while they stops.

### SUMMARY OF THE INVENTION

Accordingly, it is an object of the present invention to provide a signal lamp for a pedestrian capable of providing a walking display signal and a stop display signal as well as various additional information.

In addition, another object of the present invention is to improve visibility to clearly recognize information provided from a signal lamp for a pedestrian at several positions.

Further, yet another object of the present invention is to provide images around places where a signal lamp for a pedestrian is installed from the signal lamp for a pedestrian by remote.

According to one aspect of the present invention, there is provided a signal lamp for a pedestrian, including: a body that has a first surface, a second surface facing the first surface, and at least three side surfaces formed between the first surface and the second surface; display modules that are formed on at least three surfaces directing to different directions among the first surface, the second surface, and the three side surfaces and visually displays individually designated information; and a control module that is installed at the body and controls information that is individually displayed on the display modules, wherein at least first display module of the display modules that are formed at least three surfaces, respectively, is operated to display the information that instructs the passage or stop of the pedestrian by the control operation of the control module, the first display module is installed on any one surface of the body that directs to the other side of a road, and the second display module and the third display module are installed on other surfaces of the body, respectively, so that persons before crossing to the opposite side of the road can be viewed.

Preferably, the first display module includes a first display unit that displays a first shape designated to instruct the passage of the pedestrian, a second display unit that displays a second shape designated to instruct the stop of the pedestrian, and a third display unit that displays selected information of character, time, date, orientation, and address to instruct the passage or stop of the pedestrian.

Preferably, the individually designated information may include at least one of information that instructs the passage or stop of the pedestrian, commercial information, and non-commercial information.

Preferably, the signal lamp for a pedestrian may further include an input module that makes a request to display the designated information on the second display module or the third display module or selects the information to be displayed.

Preferably, the signal lamp for a pedestrian further includes a camera module that is formed on at least one of three or more side surfaces to provide photographed images to the control module, wherein the control module may be configured to store or remotely transmit the images provided by the camera module.

With the present invention, it can provide the walking display signal and the stop display signal as well as various additional information from the signal lamp for a pedestrian to solve the tedium of the pedestrians that wait the walking signal and provide the commercial information including various living information, advertisement information, and local information and the non-commercial information to provide publicity.

With the present invention, the display module displaying the information provided from the signal lamp for a pedestrian is disposed at several angles to improve the visibility in all directions, thereby making it possible to clearly recognize the information at several positions.

With the present invention, it can photograph the images around the intersection at which the signal lamp for a pedestrian is installed by the camera module included in the signal lamp for a pedestrian and provide them to a traffic control center positioned at a remote, such that the traffic situation and the pedestrian waiting situation at the intersection where the crosswalk is installed can be confirmed through the images in real time and the images can be used as the evidence of the traffic accidents or other accidents occurring at the crosswalk or the intersection.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram of a configuration of a signal lamp for a pedestrian according to one embodiment of the present invention;

FIG. 2 is a perspective view showing an outer appearance of the signal lamp for a pedestrian according to one embodiment of the present invention;

FIG. 3 is a front view of the signal lamp for a pedestrian according to one embodiment of the present invention;

FIG. 4 is a rear view of the signal lamp for a pedestrian according to one embodiment of the present invention;

FIG. 5 is a left side view of the signal lamp for a pedestrian according to one embodiment of the present invention;

FIG. 6 is a plan view of the signal lamp for a pedestrian according to one embodiment of the present invention;

FIG. 7 is a bottom view of the signal lamp for a pedestrian according to one embodiment of the present invention;

FIGS. 8 to 10 are exemplified diagrams for explaining screen information displayed on a first display module in the signal lamp for a pedestrian according to one embodiment of the present invention; and

FIG. 11 is a schematic view for explaining a signal lamp for a pedestrian according to another embodiment of the present invention;

FIG. 12 is a schematic view for explaining a signal lamp for a pedestrian according to another embodiment of the present invention;

FIG. 13 is a schematic view for explaining a signal lamp for a pedestrian according to another embodiment of the present invention.

### DETAILED DESCRIPTION OF PREFERRED EMBODIMENTS

Hereinafter, exemplary embodiments of the present invention will be described in detail with reference to the accompanying drawings.

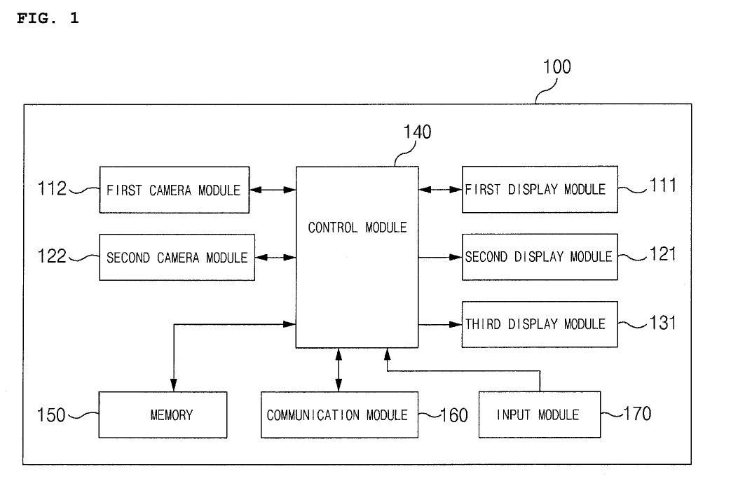

FIG. 1 is a block diagram of a configuration of a signal lamp for a pedestrian according to the present invention.

Referring to FIG. 1, a signal lamp for a pedestrian 100 according to the present invention may include a first display module 111, a second display module 121, and a third display module 131. When the first display module to the third display module 111, 121, and 131 are included in the signal lamp for a pedestrian 100, they are configured to be positioned on different planes. Since the first display module to the third display module 111, 121, and 131 are implemented on the different planes, information provided from the signal lamp for a pedestrian 100 can be viewed in all directions.

The display module 111 is configured to provide screen information that indicates a walking display signal and a stop display signal. The first display module 111 may be configured to display date of year, month, and day, a day of the week, current time, address (or house number), compass, coordinates, city name, street name, etc. To this end, the first display module 111 can be implemented using an LED device. However, the present invention is not limited thereto and can be implemented through, for example, an LCD. The first display module 111 may be a waterproof treated module. The first display module 111 can improve visibility and durability by using transparent tempered glass or a material corresponding thereto that is mounted at the outer surface thereof. Further, the first display module 111 can improve the visibility by preventing anti-glare using an anti-glare preventing material.

The second display module 121 is installed in a different direction from a surface on which the first display module 111 is installed and may be configured to display various information that is not provided from the first display module 111. For example, the second display module 121 may be configured to display various traffic information, advertisement information, living information, etc. in addition to screen information that displays the walking display signal and the stop display signal. However, the present invention is not limited thereto. For example, the second display module 121 may be configured so that information displayed on the first display module 111 is displayed on a portion of the second display module 121. To the contrary, it can be configured so that each information displayed on the second display module 121 is displayed on a portion of the first display module 111.

The third display module 131 is installed in a different direction from a surface on which the first display module 111 and the second display module 121 are installed and may be configured to display information that is displayed by the first display module 111 or the second display module 121. However, the present invention is not limited thereto. For example, the third display module 131 may be configured to select and display information that is not displayed on the second display module 121, among various traffic information, advertisement information, living information, etc. in addition to screen information that displays the walking display signal and the stop display signal.

The first display module 111, the second display module 121, and the third display module 131 may be configured using the same display device or may be configured different display devices. They can be modified according to the need or request of the designer. For example, the first display module 111 may be implemented using the LED device and the second display module 121 and the third display module 131 may be implemented using the LCD device. Further, they may be implemented as modified examples depending on various combinations.

In addition, the first display module 111, the second module 121, and the third module 131 may be implemented to have the same region or shape or have different regions or shapes. They can be modified according to the need or request of the designer. For example, they can be modified according to the various outer appearances of the signal lamp of a pedestrian 100.

The signal lamp for a pedestrian 100 may include a first camera module 112 and a second camera module 122. The first camera module 112 and the second camera module 122 are installed at a predetermined position of the signal lamp for a pedestrian 100, etc., to photograph images around the place where the signal lamp for a pedestrian 100 is installed.

Preferably, the first camera module 112 and the second camera module 122 are installed to direct to different directions. However, the present invention is not limited thereto. Also, the first camera module 112 and the second camera module 122 may be installed to direct to a designated one direction. However, the present invention is not limited thereto and can be implemented to control the photographing angle or use a zoom-in-out function by remote control.

The first camera module 112 and the second camera module 122 can be implemented using a camera technology using, for example, visible rays or infrared rays. However, the present invention is not limited thereto and can be implemented through a camera module manufactured by various camera technologies.

The signal lamp for a pedestrian 100 includes a control module 140. The control module 140 controls the operations of the first display module 111, the second display module 121, and the third display module 131. The control module 140 is associated with the traffic light that is installed at, for example, an intersection for drivers to control the time of the walking display signal and the stop display signal in the signal lamp for a pedestrian 100. To this end, the control module 140 may perform the communication with the traffic controller (not shown) that is installed at the designated position of the intersection separately from the signal lamp for a pedestrian 100. The control module 140 may be configured by, for example, a microcontroller that is configured by one integrated circuit. However, the present invention is not limited thereto and may be implemented by various computing technologies. The control module 140 may be configured to individually control the screen information to be displayed on the first display module 111, the second display module 121, and the third display module 131. In the present embodiment, the control module 140 is implemented to directly control the driving of the first display module 111, the second display module 121, and the third display module 131. However, the present invention is not limited thereto. For example, the driving module (not shown) to control the operations of the first display module 111, the second display module 121, and the third display module 131 is installed for each display module and the control module 140 may be implemented to control each driving module. For example, the control module 140 may be implemented to display the screen information that indicates the walking display signal and the stop display signal on the first display module 111. The control module 140 may display the selected information of various traffic information, advertisement information, and living information in addition to the screen information, which indicates the walking display signal and the stop display signal, on the second display module 121. The control module 140 may display on the third display module 131 the selected information among the information that are not displayed on the second display module 121, among various traffic information, advertisement information, and living information in addition to the screen information that indicates the walking display signal and the stop display signal.

The control module 140 can store the images photographed by the first camera module 112 and the second camera module 122 in the signal lamp for a pedestrian 100 or periodically transmit them through wired and wireless communication by remote according to the request.

The signal lamp for a pedestrian 100 may include a memory 150. The memory 150 stores programs or data for controlling the operations of the signal lamp for a pedestrian. For example, the memory 150 stores programs to drive the first display module 111, the second display module 121, and the third display module 131. Further, the memory 150 stores various information that will be displayed on the first display module 111, the second display module 121, and the third display module 131. The various information that is stored in the memory 150 may correspond to the screen configuration information, the commercial information, and the non-commercial information that displays, for example, the walking display signal and the stop display signal on the screen. The commercial information and the non-commercial information may include, for example, the traffic information, the advertisement information, the living information, etc. The living information may include weather information, time information, local information, geographic information, etc. The local information may include address, map, local specialty, police substation, community center telephone number, etc. The geographic information may include compass information, latitude or longitude information, etc. The information stored in the memory 150 may be information that is previously stored in the memory 150. It is transferred from the system at a remote place in real time and may be information that is temporally stored to be displayed on the first display module 111, the second display module 121, and the third display module 131. Herein, the system at a remote place may store, for example, a traffic police, a server of a traffic control head office, or a device operating server of the signal lamp of a pedestrian, etc, a time information providing server, an advertiser sever, etc. In addition, the memory 150 may store data generated according to the operation of the signal lamp for a pedestrian 100, etc, for example, image data, historical data, and control data.

The signal lamp for a pedestrian 100 may include a communication module 160. The communication module 160 may be variously implemented using a wired or wireless communication interface. The communication module 160 may be a kind of modem that receives a traffic signal control instruction from a traffic controller (not shown) through, for example, the wired communication including serial and parallel communication or the wireless communication including infrared rays, RF, Bluetooth, etc. The communication module 160 permits the internet communication to the control module 140, such that the control module 140 can periodically provide the images around the intersection photographed by the first camera module 112 and the second camera module 122 to, for example, the traffic control center positioned at a remote place according to the request. In addition, the communication module 160 can control the operation of the signal lamp for a pedestrian 100, for example, by accessing the traffic control center to the signal lamp for a pedestrian 100 through the internet communication.

In addition, the communication module 160 may be a connector that supports, for example, a RS-232 communication manner. Therefore, programs mounted on the signal lamp for a pedestrian 100 can be upgraded by connecting a manual controller (not shown) that supports the wired communication to the communication module 160 and the data store in the signal lamp for a pedestrian 100, for example, image data, historical data, and control data can be downloaded. Various data, for example, map information that can be provided from the signal lamp for a pedestrian 100, can be transmitted to the mobile terminal such as a cellular phone, for example, a short distance radio communication function through the communication module 160.

In addition, the signal lamp for a pedestrian 100 according to one embodiment of the present invention may include an input module 170 that makes a request to display the information designated in the second display module 121 or the third display module 131.

The input module 170 can be configured to generate the signal requesting to display the information designated on the second display module 121 or the third display module 131 by the operation of the pedestrian. For example, when the previously programmed advertisement is displayed on the second display module 121 or the third display module 131 and then, the corresponding input module 170 is operated by the pedestrian, the information designated by the operation signal of the corresponding input module 170, for example, the map information may be displayed. The input module 170 may be variously implemented to connect to the signal lamp for a pedestrian 100 in a wired or wireless manner and to transmit the input signal to the control module 150. For example, the input module 170 may be implemented on a pillar at which the signal lamp for a pedestrian 100 in an operating switch or button form. In addition, the input module 170 may be configured to input the selected signal to display information that the pedestrian wishes to be guided, among the information designated in the second display module 121 or the third display module 131 by the operation of the pedestrian.

In addition, the signal lamp for a pedestrian 100 according to the present invention may further include a speaker (not shown) that can output various guide information stored in the memory 150 by voice, in association with the information displayed by the second display module 121 or the third display module 131 or independently.

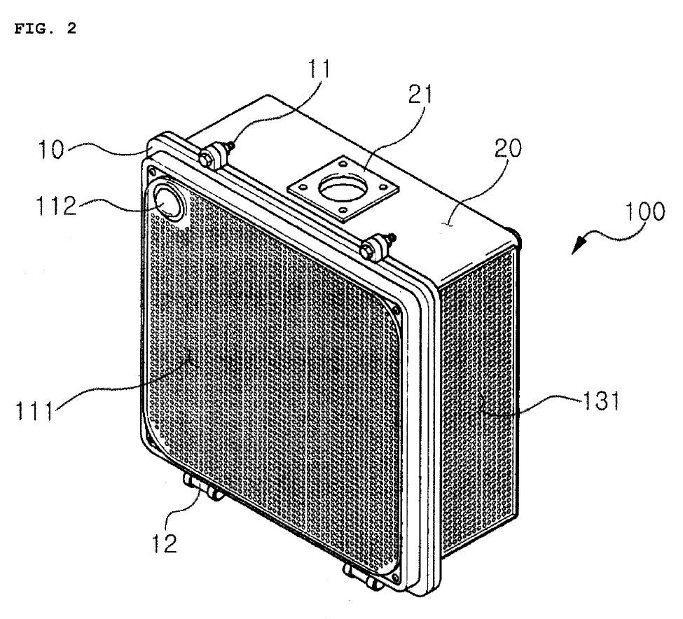

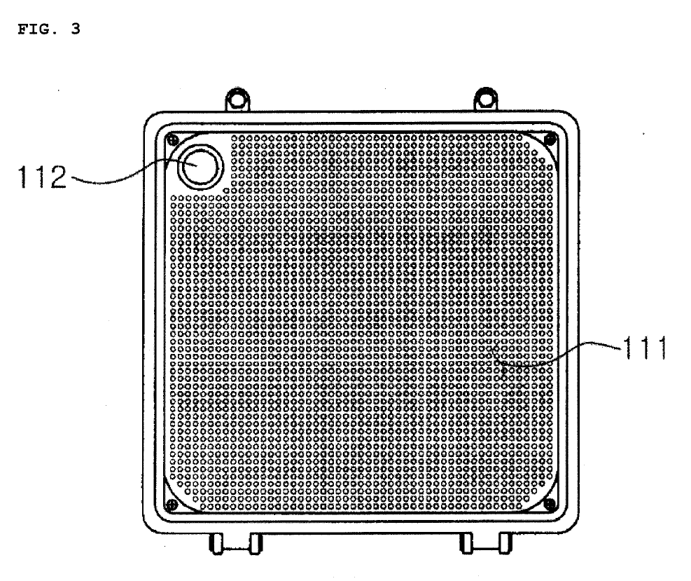

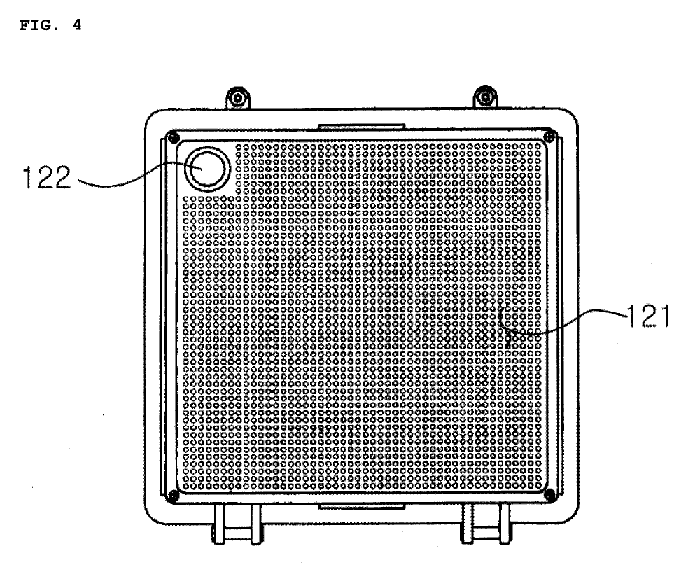

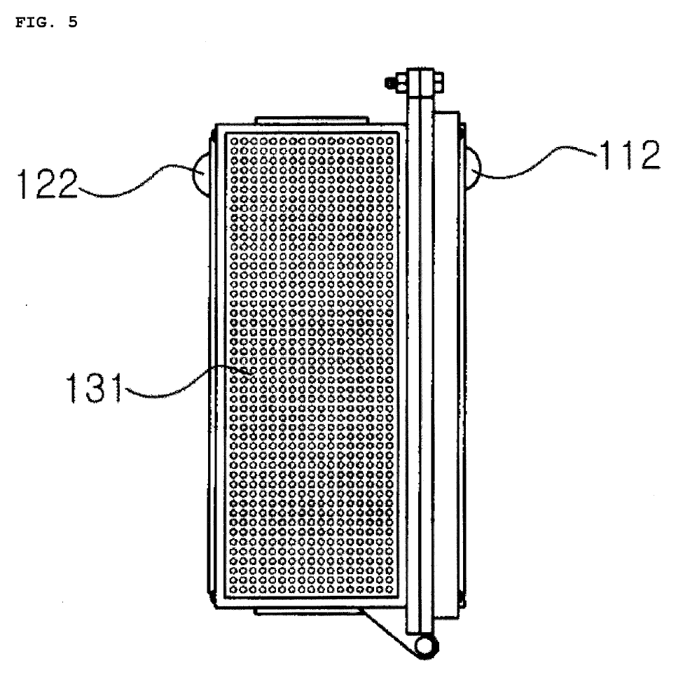

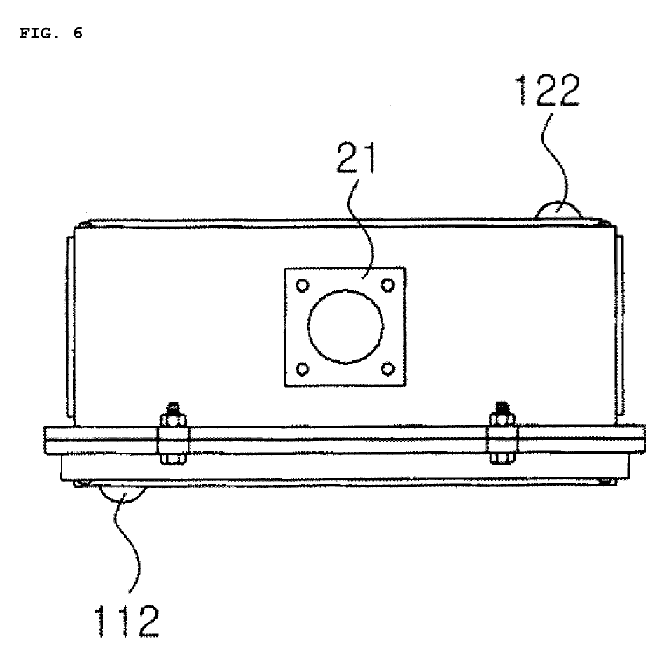

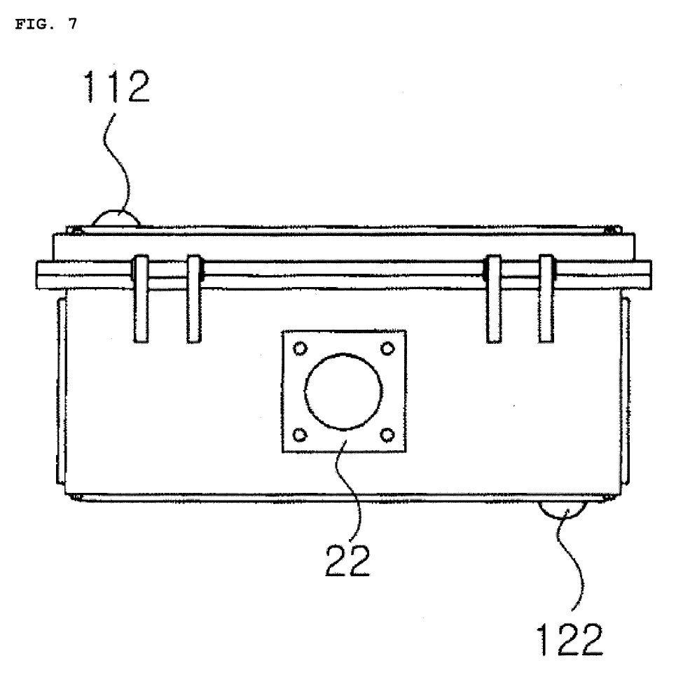

FIG. 2 is a perspective view showing an outer appearance of the signal lamp of a pedestrian according to one embodiment of the present invention and FIG. 3 is a front view thereof, FIG. 4 is a rear view thereof, FIG. 5 is a left side view thereof, FIG. 6 is a plan view, and FIG. 7 is a bottom view.

Referring to FIGS. 2 to 7, the signal lamp for a pedestrian 100 according to one embodiment of the present invention includes a first body 10 and a second body 20. The first body 10 and the second body 20 can be coupled to each other by an upper coupling part 11 and a lower coupling part 12. The coupling manner of the first body 10 and the second body 20 may be implemented by various coupling units in addition to a coupling structure shown in the drawings. In addition, although the present embodiment describes a structure that the signal lamp for a pedestrian 100 is coupled to the first body 10 and the second body 20, the present invention is not limited thereto and may be implemented in one body or by a coupling of more parts.

The first body 10 includes the first display module 111 and the first camera module 112. When a wiring for supplying power or a wiring for supplying various signals is drawn out or the signal lamp for a pedestrian is installed at the intersection, the second body 20 includes through holes 21 and 22 provided on the upper part and the lower part, respectively, to support them. The second body 20 includes the second display module 121 and the second camera module 122 that are formed on the rear surface. In addition, the second body 20 includes the third module 131 that are provided on both side surfaces thereof, respectively. One exemplary of the present invention includes the third display module 131 on both side surfaces, respectively, but the present invention is not limited thereto and the third display module 131 may be provided only at any one side surface.

The first display module 111 may be formed at a front to surface of the signal lamp for a pedestrian 100 and at the intersection so that it directs to the opposite side of a road. The first display module 111 is configured of, for example, a plurality of LED devices to be selectively turned on, thereby outputting the walking signal and the stop signal. The first display module 111 selectively turns on the LED devices to display the screen information that indicates the walking display signal and the stop display signal, for example, the shape or character information. The character information may be displayed by languages of one or several countries. In addition, the first display module 111 may display date of year, month, and day, a day of the week, current time, address, compass, coordinates, city name, street name, position, etc. on a portion region of the screen.

The first display module 111 may be the waterproof treated module. The first display module 111 can improve visibility and durability by using transparent tempered glass or a material corresponding thereto that is mounted at the outer surface thereof. In addition, the first display module 111 can improve the visibility by preventing anti-glare using an anti-glare preventing material.

The second display module 121 is installed at the rear surface of the signal lamp for a pedestrian 100 and may be configured to display various information that is not provided from the first display module 111. For example, the second display module 121 can be configured to display the various traffic information, the advertisement information, and the living information in addition to the screen information that indicates the walking display signal and the stop display signal. However, the present invention is not limited thereto. For example, the second display module 121 can be configured so that the information that is displayed on the first display module 111 is displayed on a portion of the second display module 121. To the contrary, it can be configured so that each information displayed on the second display module 121 is displayed on a portion of the first display module 111.

The third display module 131 is installed on both side surfaces of the signal lamp for a pedestrian 100. The third display module 131 may be configured to display the information displayed by the first display module 111 or the second display module 121. However, the present invention is not limited thereto. For example, the third display module 131 may be configured to select and display information that is not displayed on the second display module 121, among various traffic information, advertisement information, living information, etc. in addition to screen information that displays the walking display signal and the stop display signal.

The screen information that can be displayed by the first display module 111, the second display module 121, and the third display module 131 may correspond to various information stored in the memory 150 that is installed in the second body 20, for example, the walking display signal and the stop display signal, the commercial information and the non-commercial information. The commercial information and the non-commercial information may include the traffic information, the advertisement information, the living information, etc. The living information may include weather information, time information, local information, geographic information, etc. The local information may include address, map, local specialty, police substation, community center telephone number, etc. The geographic information may include compass information, latitude or longitude information, etc. Meanwhile, the screen information that can be displayed by the first display module 111, the second display module 121, and the third display module 131 is individually designated based on the programs stored in the memory 150 by the control module 140 that is installed in the second body 20. Therefore, the combination of the screen information that can be displayed by the first display module 111, the second display module 121, and the third display module 131 may be variously implemented. Herein, the preferred one form may be a form that the screen information of at least walking signal and stop display signal is displayed on the first display module 111 and the appropriate combination of the various commercial information or non-commercial information in addition to the walking signal and the stop display signal is displayed on the second display module 121 and the third display module 131.

As the application examples of the second display module 121 and the third display module 131, there may be a specific advertisement or logo. In other words, they shape and display the local specialty, tangible cultural asset, symbols, etc. at the places where the signal lamp for a pedestrian 100 is installed, such that the pedestrian waiting at the crosswalk can recognize the local property and the advertisement effect.

For example, they shape and display Seoul N tower (NamSan tower) in the case of Seoul in KR, pepper in the case of Cheongyang-gun in Gyeongsangbuk-do, apple in the case of Daegu, Eiffel tower in the case of Paris in France, etc. as advertisement or logo, such that the local specialty or symbols can be easily informed and recognized to and by the pedestrian.

In addition, the pedestrian that waits the cross can see the specific advertisement or logo the local rather than the pedestrian waiting meaninglessly, such that the tedium or promptness of time can be solved.

In addition, the local characteristics are advertised, such that visitors from other locals can easily recognize which places they are positioned currently and the publicity can be obtained through the local advertisement. The advertisement or logo that is displayed on the second display module 121 and the third display module 131 can be changed to inform it when there are events or games at the local as needed. When the advertisement or logo is changed, the corresponding information is downloaded in the memory 150 that is installed in the second body 20 or the separate memory that is installed to be replaced, such that the newly changed advertisement or logo can be displayed for a predetermined period. The various information that is displayed on the second display module 121 and the third display module 131 is not limited only to the above-mentioned description and can be optionally controlled according to the place where the signal lamp for a pedestrian 100 is installed or the geographical environment, that is, the traffic amount of the vehicle, the traffic amount of the pedestrian, etc.

In the signal lamp for a pedestrian 100 according to the present invention, the first display module 111, the second display module 121, and the third display module 131 may be implemented using the LED or LCD devices, such that they are inclined to improve the case where the screen information is not clearly shown due to sunlight. For example, they can be formed to be inclined below about 30° and the sunlight cover can be installed.

In addition, the signal lamp for a pedestrian 100 according to the present invention is installed so that the first display module 111, the second display module 121, and the third display module 131 direct to different directions. Therefore, the screen information on the walking display and the stop display signal of the pedestrian can be provided by the first display module 111 and the visibility with respect to the pedestrian which is positioned at several positions based on the signal lamp for a pedestrian 100 can be improved by the second display module 121 and the third display module 131. For example, the pedestrians that wait the walking signal positioned near the signal lamp for a pedestrian 100 can receive various advantageous information that is displayed through the second display module 121 and the third display module 131 in all directions regardless of whether they are positioned at the left of the signal lamp for a pedestrian 100, the right thereof, the back thereof,

The first display module 111, the second display module 121, and the third display module 131 can be implemented using the same display device or using different display devices. They can be modified according to the need or request of the designer. For example, the first display module 111 may be implemented using the LED device and the second display module 121 and the third display module 131 may be implemented using the LCD device. Further, they may be implemented as modified examples depending on various combinations.

Meanwhile, the first camera module 112 is installed at a portion region, for example, a left upper at the front surface of the first body 10. The first camera module 112 is positioned on the front surface of the signal lamp for a pedestrian 100, such that when it is installed at a crosswalk, it directs to an opposite side of a road, thereby making it possible to photograph images of an opposite side of a road including the crosswalk.

The second camera module 122 is positioned on the rear surface of the signal lamp for a pedestrian 100, such that when it is installed at the crosswalk, it directs to the opposite side of the road before crossing the crosswalk, thereby making it possible to photograph the image of the opposite side of the road. Of course, in the present embodiment, each of the first camera module 112 and the second camera module 122 is fixedly installed to photograph one direction on the front and rear surfaces. However, the directions of each camera modules 112 and 122 can be controlled, such that they can be implemented to control the photographing angle by the operation at remote or use the Zoom-in-out function.

The first camera module 112 and the second camera module 122 can be applied with various camera technologies including the camera technology using, for example, visible rays or infrared rays.

The driving of the first display module 111, the second display module 121, and the third display module 131 can be made by the control of the control module 140 that is installed in the second body 20.

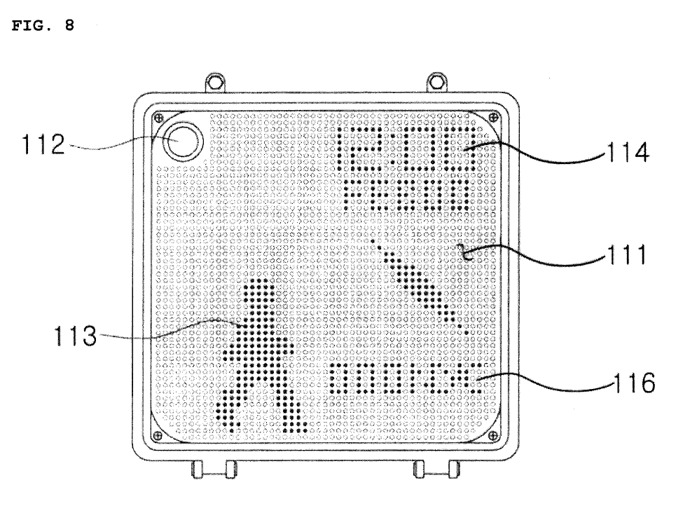

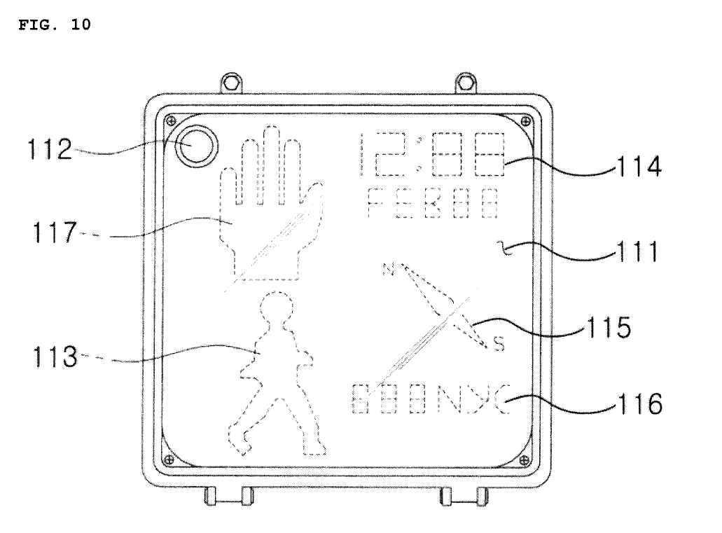

FIGS. 8 to 10 are exemplified diagrams for explaining the screen information that is displayed on the first display module 111 in the signal lamp for a pedestrian according to one embodiment of the present invention.

FIG. 8 is an exemplified diagram of the screen of the first display module 111 in the state of the walking signal in the signal lamp for a pedestrian. Referring to FIG. 8, the first display module 111 is configured using the plurality of LED devices. In the first display module 111, a pedestrian display unit 113 is formed at the left lower region, a date and time display unit 114 are formed at the right upper region, a compass display unit 115 is formed at the right middle region, a position display unit 116 is formed at the right lower region. The pedestrian display unit 113 may be implemented in various forms. For example, it can be operated so that it is turned on at the initial of the walking signal period and then, turned off as approaching the time when the walking signal period is ended. In addition, the pedestrian display unit 113 has the shape where the pedestrian is walking and can be implemented by the stop mode having only one shape and implemented in a non-stop mode having several shapes, such that the fact that the pedestrian is walking can be more realized. The LEDs that configure each display unit of the first display module 111 are turned on or off differently from the LEDs that configures the background regions, such that they can be recognized by the pedestrians. Therefore, the LEDs that configure the first display module 111 may be formed so that the LEDs having colors configuring the background regions and the LEDs configuring the display units are properly arranged. Alternatively, in the state where the entire region of the first display module 111 is arranged in the LED of three primary colors, it may be implemented by turning on or turning off only the LEDs corresponding to each display unit by programming selectively or in a differentiated color.

The date and the current time can be guided to the pedestrians through the date displayed on the first display module 111 and the time display unit 114. The orientation can be guided to the pedestrians through the compass display unit 115. Also, the current position can be guided to the pedestrians through the position display unit 116.

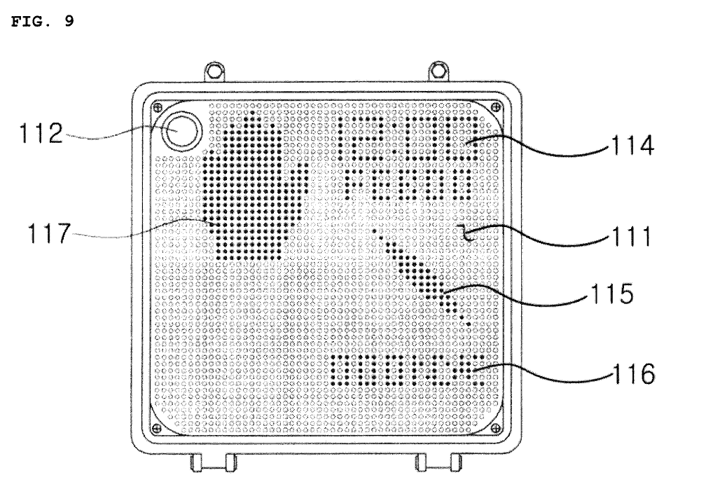

FIG. 9 is an exemplified diagram of a screen of the first display module 111 in the stop state in the signal lamp for a pedestrian. Referring to FIG. 9, in the first display module 111 the LEDs that configure the walking display unit 113 are turned on and only the LEDs that indicate the background are turned on as shown in FIG. 8 and the stop display unit 117 is instead displayed on the left upper area. The stop display unit 117 has, for example, the shape where the person's palm is spread. The shape of the stop display unit 117 can be variously modified according to the designer.

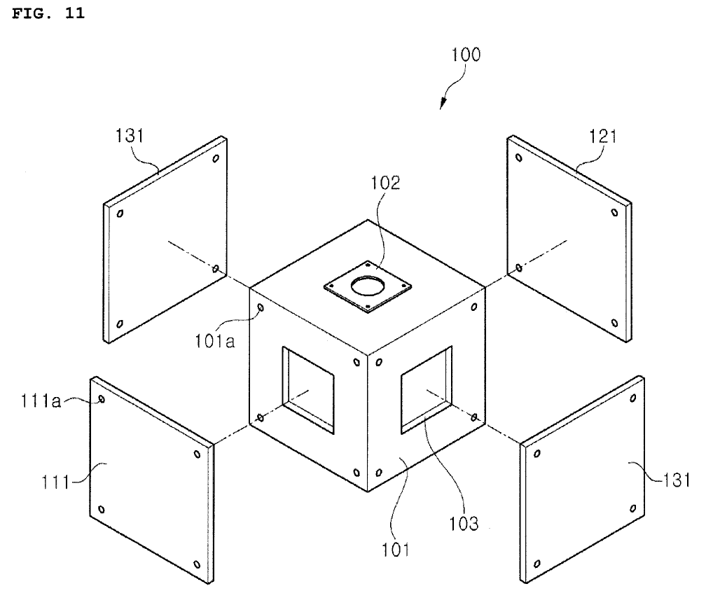

FIG. 11 is a schematic view for explaining a signal lamp for a pedestrian according to another embodiment of the present invention.

Referring to FIG. 11, the signal lamp for a pedestrian 100 according to another embodiment of the present invention includes a first display module 111, a second display module 121, and two third display modules 131 as each unit, wherein each unit is coupled to a body 101. To this end, the first display module 111 is provided with a fixture 111a and the second display module 121 and the third display module 131 are provided with the corresponding fixture. In addition, the body 101 is provided with fixtures 101a each of which corresponds to each fixture of the first display module 111 to the third display module 131. The first display module 111, the second display module 121, the two third display modules 131 may be coupled to these fixtures by, for example, a screw.

In addition, the body 101 is formed with an open area 103 that draws out wirings for supplying power and signals to the first display module 111, the second display module 121, and the two third display modules 131. The upper or lower portions of the body 101 are provided with a through hole 102 that draws out a wiring for supplying power or a wiring for supplying various signals or supports the signal lamp for a pedestrian 100 when the signal lamp for a pedestrian 100 is installed at an intersection.

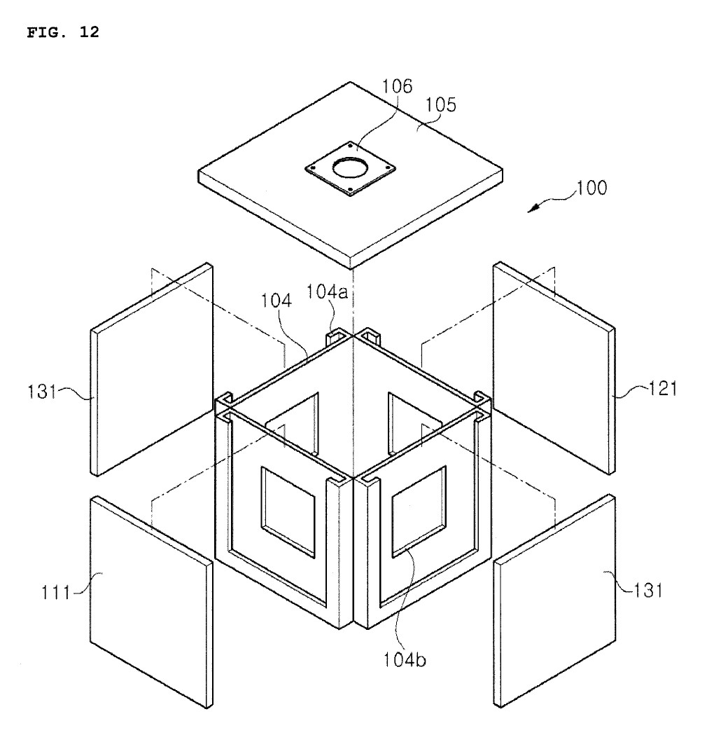

FIG. 12 is a schematic view for explaining a signal lamp for a pedestrian according to another embodiment of the present invention.

Referring to FIG. 12, the signal lamp for a pedestrian 100 according to another embodiment of the present invention includes a first display module 111, a second display module 121, and two third display modules 131 as each unit, wherein each unit is coupled to a body 101. The body 104 is provided with fixtures 104a that fit the first display module 111, the second display module 121, and the two display modules 131 in all sides thereof. In addition, the body 104 is provided with an open area 104b that draws out wirings for supplying power and signals to the first display module 111, the second display module 121, and the two third display modules 131.

After the first display module 111, the second display module 121, and the two third display modules 131 slidably fit in the body 104 by using the fixtures 104a that are formed on the body 104, a cover 105 is covered on the upper portion of the body 104. The cover 105 is provided with a through hole 106 that draws out a wiring for supplying power or a wiring for supplying various signals or supports the signal lamp for a pedestrian 100 when the signal lamp for a pedestrian 100 is installed at an intersection.

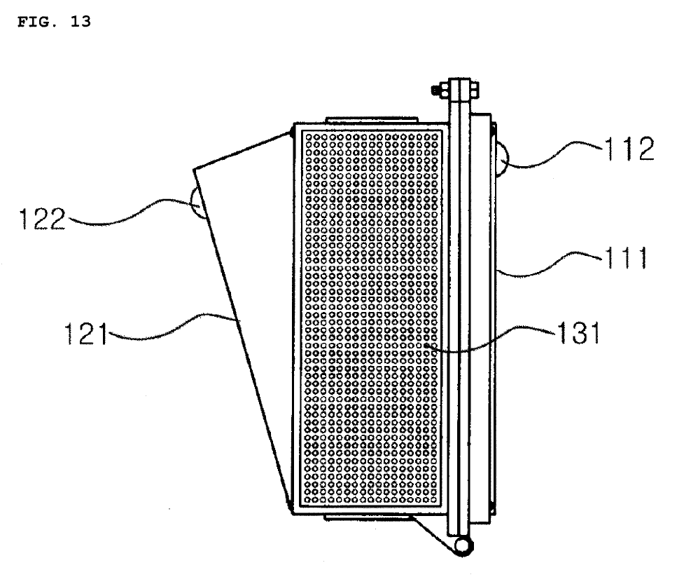

FIG. 13 is a schematic view for explaining a signal lamp for a pedestrian according to another embodiment of the present invention. Referring to FIG. 13, the signal lamp for a pedestrian includes a first display module 111 including a first camera module 112, a second display module 121 including a second camera module 122, and a third display module 131, wherein the second display module 121 is formed to be inclined downward. This can effectively improve the visibility of the second display module 121 in case that the screen information is not clearly displayed due to sunlight when the second display module 121 is implemented as, for example, the LCD panel.

As described above, the signal lamp for a pedestrian according to the present invention was described with reference to the exemplified drawings. The present invention is not limited by the above-mentioned embodiment and drawings and various modifications and changes thereof can be made by those skilled in the art to which the present invention pertains.

For example, one embodiment of the present invention described a square structure that the body has the upper surface and the lower surface and a cross section in a horizontal direction having four side surfaces therebetween. However, the present invention is not limited thereto. For example, another embodiment of the present invention can be implemented by the modification example that a cross section in a horizontal direction forms a triangle, including the upper surface and the lower surface and three side surfaces. Similarly, another embodiment of the present invention can be implemented by the modification example that a cross section in a horizontal direction forms a pentagon, including the upper surface and the lower surface and five side surfaces. Further, another embodiment of the present invention can be implemented as the modification example that a cross section in a horizontal direction forms 6, 7 . . . N square shape, including the upper surface and the lower surface and 6, 7 . . . N side surfaces, as needed.

In addition, one embodiment of the present invention described that the first display module is installed at the front surface, the second display module is installed at the rear surface, and the third display module is installed at both side surfaces. However, the present invention is not limited thereto. For example, in another embodiment of the present invention, the first display module may be installed at the front surface, the second display module may be installed at the rear surface, and the third display module may be installed at the bottom surface. The modification example that the third display module is installed at the bottom surface can provide the increased visibility to the persons positioned just below when it is installed to be higher than the height of the person. Similarly, in another embodiment of the present invention, the first display module may be installed at the front surface, the second display module may be installed at the rear surface, and the third display module may be installed at the upper surface. The modification example that the third display module is installed on the upper surface can provide the increased visibility as the pedestrian can look down when the signal lamp for a pedestrian is installed to be lower than the height of the person. In addition, as another embodiment of the present invention, the connection part for installing the signal lamp for a pedestrian is formed at any one of the upper surface or the lower surface and the display module may be installed at all the side surfaces including any one of the upper surface or the lower surface on which the connection part is not formed.

Further, in the embodiment of the present invention, the body has a square shape and the upper surface, the lower surface, and the side surfaces may be implemented to be vertical. However, the present invention is not limited thereto. For example, the upper surface or the lower surface may be formed to be inclined. In addition, the side surfaces are positioned with respect to the upper surface or the lower surface, but may be inclinedly positioned away from the vertical form. When the side surfaces are positioned to be inclined, the shape of the side surfaces may be implemented in a trapezoidal shape whose upper part or lower upper is narrow or wide rather than a square or a rectangle. As another embodiment of the present invention, each side surface is not formed in one plane from the upper part to the lower part and the middle part is more convex or concave than the upper part or the lower part to form two planes, such that the vertical cross section can be implemented to have the shape of “< >” or > <”.

Moreover, although the embodiment of the present invention described the structure that has the upper surface, the lower surface, and four side surfaces, the upper surface and the lower surface can be said as both side surfaces according to the viewing angle. In other words, as shown in FIG. 2, the signal lamp for a pedestrian is rotated by 90° clockwise, such that the upper surface or the lower surface thereof can be described as both side surfaces.

In addition, the connection part is formed on at least one of both side surfaces and three side surfaces are formed between both side surfaces, wherein the side surface may be implemented in a shape where a width is longer than a length. Since the structure has a shape where the width is longer than the length, the pedestrian passage signal and the stop signal may be arranged in the horizontal arrangement and the advertisement draft may also be arranged in the horizontal arrangement, thereby making it possible to improve the visibility. Similarly, it may be implemented in a structure that the connection part is formed on at least any one of both side surfaces and four side surfaces are formed between both side surfaces.

What is claimed is:

1. A signal lamp for a pedestrian, comprising:
a body that has a first surface, a second surface facing the first surface, and at least three side surfaces formed between the first surface and the second surface;
display modules that are formed on at least three surfaces directing to different directions among the first surface, the second surface, and the three side surfaces and visually displays individually designated information; and
a control module that is installed at the body and controls information that is individually displayed on the display modules,
wherein at least first display module of the display modules that are formed at least three surfaces, respectively, is operated to display the information that instructs the passage or stop of the pedestrian by the control operation of the control module, and
the first display module is installed on any one surface of the body that directs to the other side of a road, and the second display module and the third display module are installed on other surfaces of the body, respectively, so that persons before crossing to the opposite side of the road can be viewed.

2. The signal lamp for a pedestrian according to claim 1, wherein the first display module includes a first display unit that displays a first shape designated to instruct the passage of the pedestrian and a second display unit that displays a second shape designated to instruct the stop of the pedestrian, and a third display unit that displays selected information of character, time, date, orientation, and address to instruct the passage or stop of the pedestrian.

3. The signal lamp for a pedestrian according to claim 1, wherein the individually designated information may include at least one of information that instructs the passage or stop of the pedestrian, commercial information, and non-commercial information.

4. The signal lamp for a pedestrian according to claim 1, further comprising an input module that makes a request to display the designated information on the second display module or the third display module or selects the information to be displayed.

5. The signal lamp for a pedestrian according to claim 1, further comprising a camera module that is formed on at least one of three or more side surfaces to provide photographed images to the control module,
wherein the control module may be configured to store or remotely transmit the images provided by the camera module.
